(19) United States
(12) Patent Application Publication
(10) Pub. No.: US 2026/0100358 A1
(43) Pub. Date: Apr. 9, 2026

(54) LITHIUM-ION BATTERY

(71) Applicant: TOYOTA JIDOSHA KABUSHIKI KAISHA, Toyota-shi (JP)

(72) Inventor: Daisuke HORIKAWA, Toyota-shi (JP)

(73) Assignee: TOYOTA JIDOSHA KABUSHIKI KAISHA, Toyota-shi (JP)

(21) Appl. No.: 19/235,882

(22) Filed: Jun. 12, 2025

(30) Foreign Application Priority Data
Oct. 4, 2024 (JP) 2024-174881

(51) Int. Cl. H01M 4/40; H01M 10/0525

(52) U.S. Cl. CPC H01M 4/405; H01M 10/0525

(57) ABSTRACT

The lithium-ion battery includes a cathode, an anode, and an electrolyte. The anode includes a metal anode layer. The metal anode layers include Li, a first element, and a second element. The second element is different from the first element. The first element is at least one selected from the group consisting of Mg, Ga, Ag, Au and Cd. The second element is at least one selected from the group consisting of Na, Mg, Al, Si, Ca, Sc, Ti, Mn, Zn, Ga, Ge, Sr, Rh, Y, Zr, Pd, In, Sn, Ba, Ag, Pb, Ir, Au, Pt, Bi, Sb, Cd, Nd, and Tl. The relation “M₁:M₂=60:40 to 98:2” is satisfied. “M₁” indicates the mass of the first element included in the metal anode layer. “M₂” indicates the mass of the second element included in the metal anode layer.

### CROSS-REFERENCE TO RELATED APPLICATION

This application claims priority to Japanese Patent Application No. 2024-filed on Oct. 4, 2024. The disclosure of the above-identified application, including the specification, drawings, and claims, is incorporated by reference herein in its entirety.

### BACKGROUND

### 1. Technical Field

The present disclosure relates to a lithium-ion battery.

### 2. Description of Related Art

Japanese Unexamined Patent Application Publication No. 2022-140029 (JP 2022-140029 A) discloses an anode material containing lithium (Li) as an anode active material.

### SUMMARY

Metal anodes have been studied. The metal anode includes Li as an anode active material. The charge-discharge reaction in the metal anode is a dissolution-precipitation reaction of Li. Repeated charging and discharging may cause Li dendrites to grow in the metal anode. Deactivation of Li dendrites may form dead Li and reduce capacity. Further, accumulation of dead Li may cause the metal anode to swell. That is, there is room for improvement in cycle durability.

An object of the present disclosure is to improve cycle durability.

1. In one aspect of the present disclosure, a lithium-ion battery (hereinafter may be abbreviated as “battery”) may have, for example, the following configuration.

The battery includes a cathode, an anode, and an electrolyte.

The anode includes a metal anode layer.

The metal anode layer includes Li, a first element, and a second element.

The second element is different from the first element.

The first element is at least one kind selected from the group consisting of Mg (magnesium), Ga (gallium), Ag (silver), Au (gold), and Cd (cadmium).

The second element is at least one kind selected from the group consisting of Na (sodium), Mg (magnesium), Al (aluminum), Si (silicon), Ca (calcium), Sc (scandium), Ti (titanium), Mn (manganese), Zn (zinc), Ga (gallium), Ge (germanium), Sr (strontium), Rh (rhodium), Y (yttrium), Zr (zirconium), Pd (palladium), In (indium), Sn (tin), Ba (barium), Ag (silver), Pb (lead), Ir (iridium), Au (gold), Pt (platinum), Bi (bismuth), Sb (antimony), Cd (cadmium), Nd (neodymium), and Tl (thallium).

A relationship “M₁:M₂=60:40 to 98:2” is satisfied.

The “M₁” represents a mass of the first element contained in the metal anode layer.

The “M₂” represents a mass of the second element contained in the metal anode layer.

The metal anode layer in the present disclosure includes the first element and the second element. As shown in the relationship “M₁:M₂=60:40 to 98:2,” the first element is the primary component and the second element is the secondary component. During precipitation of Li (during charging), the first element and the second element may be alloyed with Li. Due to the alloying, the reaction unevenness in the in-plane direction can be reduced. Therefore, the metal anode layer may grow flat. That is, generation of Li dendrites may be reduced. Thus, improvement in cycle durability is expected. If the mass fraction of the second element with respect to the sum of the first element and the second element is less than 2%, there is a possibility that the desired cycle durability cannot be obtained. If the mass fraction of the second element with respect to the sum of the first element and the second element is more than 40%, there is a possibility that the desired cycle durability cannot be obtained.

2. The battery according to “1” above may include, for example, the following configuration.

The metal anode layer includes a first phase and a second phase.

The first phase includes Li and the first element.

The second phase includes Li and the second element.

In a cross section of the metal anode layer, a relationship “1×10⁻⁵%≤S₂/S₁≤90%” is satisfied.

The “S₁” represents a total area of the first phase in the cross section.

The “S₂” represents a total area of the second phase in the cross section.

As long as the relationship “M₁:M₂=60:40 to 98:2” is satisfied in “1” above, Li, the first element, and the second element may form a solid solution (uniform solid phase) by being dissolved in each other, or may be separated in phase. When the phase separation occurs, the reaction is generally uneven, and it is therefore considered that the charging resistance increases as compared with the solid solution. However, it has been found that the charging resistance may rather be reduced when the relationship “1×10⁻⁵%≤S₂/S₁≤90%” is satisfied in the combination of the first element and the second element. Since the reaction unevenness is reduced by reducing the charging resistance, improvement in cycle durability is expected.

3. The battery according to “2” above may include, for example, the following configuration.

The first phase includes a continuous phase.

The second phase includes a dispersed phase dispersed in particles in the continuous phase.

In the cross section of the metal anode layer, an aspect ratio of the second phase is 1 to 4.

For example, the first phase and the second phase may form a sea-island structure. When the aspect ratio of the second phase (dispersed phase) is 1 to 4, reduction in charging resistance is expected.

4. The battery according to any one of “1” to “3” above may include, for example, the following configuration.

The anode further includes a substrate.

The metal anode layer is provided on a surface of the substrate.

The electrolyte includes an electrolyte solution.

It is considered that a reaction in which Li is desorbed from the solvent in the electrolyte solution during charging is a rate-limiting reaction and the charging resistance is increased. It has been found that the activation energy of the rate-limiting reaction can be reduced at the interface between the metal anode layer and the substrate in the present disclosure. By the reduction in activation energy, reduction in charging resistance is expected. The electrolyte of the present disclosure is not limited to the electrolyte solution, and may also include a solid electrolyte and a gel electrolyte.

5. In one aspect of the present disclosure, the battery may have, for example, the following configuration.

The battery includes a cathode, an anode, and an electrolyte solution.

The anode includes a substrate and a metal anode layer.

The metal anode layer is provided on a surface of the substrate.

The metal anode layer includes Li, a first element, and a second element.

The second element is different from the first element.

The first element is at least one kind selected from the group consisting of Mg, Ga, Ag, Au, and Cd.

The second element is at least one kind selected from the group consisting of Na, Mg, Al, Si, Ca, Sc, Ti, Mn, Zn, Ga, Ge, Sr, Rh, Y, Zr, Pd, In, Sn, Ba, Ag, Pb, Ir, Au, Pt, Bi, Sb, Cd, Nd, and Tl.

A relationship “M₁:M₂=60:40 to 98:2” is satisfied.

The “M₁” represents a mass of the first element contained in the metal anode layer.

The “M₂” represents a mass of the second element contained in the metal anode layer.

The metal anode layer includes a first phase and a second phase.

The first phase includes Li and the first element.

The second phase includes Li and the second element.

In a cross section of the metal anode layer, a relationship “1×10⁻⁵%≤S₂/S₁≤90%” is satisfied.

The “S₁” represents a total area of the first phase in the cross section.

The “S₂” represents a total area of the second phase in the cross section.

The first phase includes a continuous phase.

The second phase includes a dispersed phase dispersed in particles in the continuous phase.

In the cross section of the metal anode layer, an aspect ratio of the second phase is 1 to 4.

An embodiment of the present disclosure (hereinafter may be abbreviated as “present embodiment”) and an example of the present disclosure (hereinafter may be abbreviated as “present example”) will be described below. However, the present embodiment and the present example are not intended to limit the technical scope of the present disclosure. The present embodiment and the present example are illustrative in all respects. The present embodiment and the present example are not restrictive. The technical scope of the present disclosure includes all modifications that fall within the meaning and scope equivalent to the claims. For example, it is originally planned to extract appropriate configurations from the present embodiment and combine such configurations as appropriate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram of a lithium-ion battery according to the present embodiment;

FIG. 2 is a first conceptual diagram of an anode in the present embodiment;

FIG. 3 is a second conceptual diagram of the anode in the present embodiment;

FIG. 4A is Table 1 showing experimental results;

FIG. 4B is Table 1 showing experimental results;

FIG. 5A is Table 2 showing experimental data;

FIG. 5B is Table 2 showing experimental data;

FIG. 6A is Table 3 showing experimental results; and

FIG. 6B is Table 3 showing experimental results.

### DETAILED DESCRIPTION OF EMBODIMENTS

### Terms and Phrases

“comprising,” “including,” “having,” and variations thereof are open-ended representations. The open-ended configuration may or may not further include additional elements in addition to the essential elements.

The geometric terms are not to be construed in a strict sense. Examples of geometric terms include “parallel”, “perpendicular”, and “orthogonal”. For example, directions, angles, distances, and the like may be relatively displaced within a range in which substantially the same or similar functions are obtained.

Elements described in a “singular form” may also include a plural form unless otherwise specified. For example, the particles may represent a plurality of particles, a collection of particles, and a granulate. Note that the “plurality of particles” may be referred to as a “particle group”.

Numerical ranges such as “m to n %” include upper and lower limits unless otherwise specified. That is, “m to n %” indicates a numerical range of “m % or more and n % or less”. In addition, “m % or more and n % or less” includes “more than m % and less than n %”. The terms “greater than or equal to” and “less than or equal to” are represented by an equal signed inequality sign “≤, ≥”. “Super” and “less than” are represented by inequality signs “<, >” that do not include equal signs. A numerical value arbitrarily selected from within the numerical value range may be a new upper limit value or a new lower limit value. For example, a new numerical range may be set by appropriately combining numerical values within the numerical range with numerical values described in other parts of the present specification, tables, drawings, and the like.

The devices, software, and the like used for measuring various values are merely examples. Equivalents of the illustrated devices may be used. If an equivalent is used, the measurement conditions may be adjusted to suit the device.

“SOC (State Of Charge)” indicates the percentage of discharged electricity excluding the percentage of discharged electricity from the condition in which the cell is fully charged. SOC of full charge is 100%. SOC of fully discharged conditions is 0%.

The mass-ratio of the first element and the second element “M₁:M₂” may be specified in the following manner. SOC of the cell is adjusted to 0%. When the battery is disassembled, the anode is recovered. A solution is formed by dissolving a total amount of the anode in an acid. The sample is prepared by appropriately diluting the solution. ICP-AES (Inductively coupled plasma atomic emission spectroscopy), the mass-ratio “M₁:M₂” between the first element and the second element included in the sample is specified. When the first element includes a plurality of elements, the mass “M₁” of the first element indicates the sum of the plurality of elements. The same applies to the second element.

The area ratio “S₂/S₁” between the first phase and the second phase may be specified in the following steps. SOC of the cell is adjusted to 0%. When the battery is charged at a low rate, the charge per area of the metal anode layer is adjusted to about 3.5 mAh/cm². After charging, the battery is disassembled to recover the anode. Note that the charge amount may be adjusted after recovery of the anode. In an environment of −40° C., the metal anode layer is subjected to cross-sectional processing by an ion milling apparatus to prepare a cross-sectional sample. The cross-sectional sample is substantially parallel to the normal direction of the surface of the metal anode layer. The cross-sectional sample may not be completely parallel to the normal direction. According to SEM-EDS (Scanning electron microscope-energy dispersive x-ray spectroscopy), elemental mapping analyses of the cross-sectional samples are performed. The elemental mapping image is subjected to image analysis. By counting the number of pixels of the first element, the total area “S₁” of the first phase is obtained. By counting the number of pixels of the second element, the total area “S₂” of the second phase is obtained. By dividing the area “S₂” by the area “S₁”, the area ratio “S₂/S₁” is obtained. Area ratios are expressed as percentages (%). Note that the image analysis may be performed by software. For example, “ImageJ” or the like may be used.

The aspect ratio of the dispersed phase (island phase) is specified by the following procedure. In the element mapping image obtained above, 10 dispersed phases dispersed in a particulate form are selected. The smallest circumscribed rectangle (MBR) is fitted to the dispersed phase. The long side “d_{L}” and the short side “d_{S}” of MBR are specified. By dividing the long side “d_{L}” by the short side “d_{S}”, the aspect ratio “d_{L}/d_{S}” is obtained. An arithmetic mean of 10 measurements is employed.

### Battery

In some embodiments, the battery may have a bipolar structure. In some embodiments, the battery may have a monopolar structure. As an example, a battery of a monopolar structure may be described.

In some embodiments, the battery may be an anode-free battery. In the anode-free cell, the anode active material (Li) is not present in the anode in the condition prior to the first charge. Li is deposited on the anode for the first time during the first charge. In some embodiments, the battery may be an anode-free battery that has been charged one or more times.

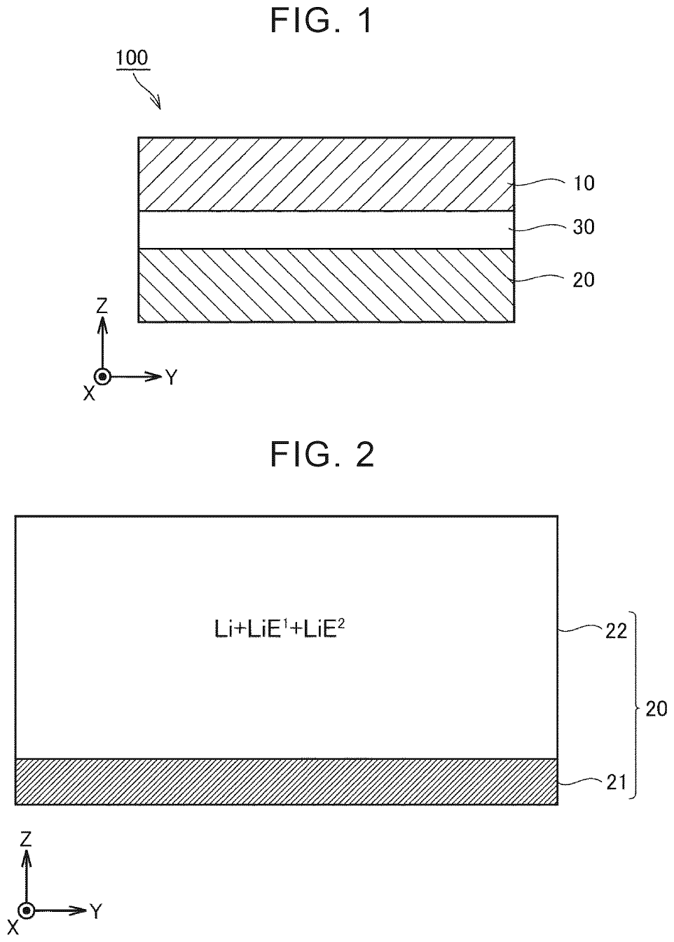

FIG. 1 is a conceptual diagram of a lithium-ion battery according to the present embodiment. The battery 100 includes a cathode 10, an anode 20, and an electrolyte 30. The anode 20 faces the cathode 10. A separator (not shown) separates the cathode 10 from the anode 20. When the electrolyte 30 is an electrolyte solution, an electrically insulating porous film is disposed between the cathode 10 and the anode 20 as a separator. The separator (porous membrane) is impregnated with an electrolyte solution. When the electrolyte 30 is a solid electrolyte, the electrolyte 30 may function as a separator. For example, the cathode 10 and the anode 20 may form a winding type power generation element (electrode body). For example, the cathode 10 and the anode 20 may form a stacked power generation element. The battery 100 may include an exterior body (not shown). The exterior body may house the power generating element. The outer casing may include, for example, a metallic case, a pouch made of a Al laminated film, or the like.

### Anode

FIG. 2 is a first conceptual diagram of the anode according to the present embodiment. The anode 20 may include, for example, a substrate 21. The substrate 21 may support the metal anode layer 22. The substrate 21 has conductivity. The substrate 21 may be referred to as a “current collector”, for example. The substrate 21 may be, for example, a conductive sheet. The substrate 21 may include a material that is less likely to be alloyed with Li than a constituent material of the metal anode layers 22. The substrate 21 may include, for example, a metal foil, a conductive resin sheet, or the like. The substrate 21 may include, for example, a Cu (copper) foil, a Cu alloy foil, a Ni (nickel) foil, a Ni alloy foil, or the like. The thickness of the substrate 21 may be, for example, 1 μm or more, 5 μm or more, 10 μm or more, 20 μm or more, or 50 μm or more. The thickness of the substrate 21 may be, for example, 100 μm or less, 50 μm or less, 20 μm or less, or 10 μm or less.

The anode 20 includes a metal anode layer 22. The metal anode layer 22 may be formed on the surface of the substrate 21. A metal anode layer 22 may be formed on one surface of the substrate 21. A metal anode layer 22 may be formed on both surfaces of the substrate 21. The metal anode layer 22 may be referred to as a “anode active material layer”. In the metal anode layers 22, Li dissolution and precipitation may occur. The deposition of Li may cause the metal anode layers 22 to swell. The dissolution of Li may cause the metal anode layers 22 to shrink. That is, the thickness of the metal anode layers 22 may increase or decrease with the change of SOC. At a SOC of 100%, the thickness of the metal anode layers 22 may be, for example, 500 μm from 5 nm.

The metal anode layers 22 include Li, a first element “E¹” and a second element “E²”. In theoretically, at a SOC of 0%, the metal anode layers 22 may not contain Li. The composition of the metal anode layer 22 may be specified, for example, in a SOC of 30 to 100%. Thus, for example, at a SOC of 50%, the metal anode layer 22 may be said to Li contain the first element “E¹” and the second element “E²”.

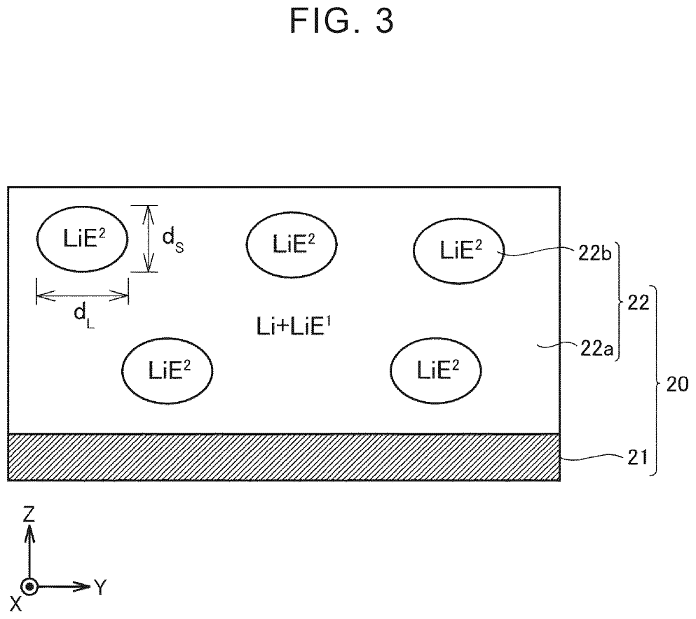

Li, the first element “E¹” and the second element “E²” may form, for example, a solid solution (homogeneous phase). In FIG. 2 and FIG. 3, for example, “LiE¹” indicates an intermetallic compound or an alloy of Li and the first element. For example, “Li+LiE¹+LiE²” refers to a solid solution of Li, “LiE¹” and “LiE²”. An example of the “LiE¹” is “LiAg”, for example. An example of the “LiE²” is “LiIn”, for example.

The first element is at least one selected from the group consisting of Mg, Ga, Ag, Au and Cd.

The second element is at least one selected from the group consisting of Na, Mg, Al, Si, Ca, Sc, Ti, Mn, Zn, Ga, Ge, Sr, Rh, Y, Zr, Pd, In, Sn, Ba, Ag, Pb, Ir, Au, Pt, Bi, Sb, Cd, Nd, and Tl. The second element is different from the first element. For example, combinations in which both the first element and the second element are Ag are not acceptable. As long as the elements do not overlap, the first element and the second element may each independently include a plurality of elements.

Regarding the mass ratio between the first element and the second element “M₁:M₂”, “M₁:M₂=60:40 to 98:2” is satisfied. For example, “M₁:M₂=70:30 to 98:2”, “M₁:M_{2=80:20} to 98:2” or “M₁:M₂=90:10 to 98:2” may be satisfied. For example, “M₁:M₂=60:40 to 90:10”, “M₁:M₂=60:40 to 80:20”, or “M₁:M₂=60:40 to 70:30” may be satisfied.

FIG. 3 is a second conceptual diagram of the anode according to the present embodiment. The metal anode layer 22 may be phase-separated. The metal anode layers 22 may include, for example, a first phase 22a and a second phase 22b. The first phase 22a and the second phase 22b may, for example, form an island-in-the-sea configuration. For example, the first phase 22a may form a continuous phase (sea phase). The second phase 22b may form a dispersed phase (island phase). The dispersed phase may be dispersed in particulate form in the continuous phase.

The first phase 22a includes Li and a first element. The first phase 22a may include a solid solution of Li and a first element. The first phase 22a may include an intermetallic compound of Li and the first element, an alloy, or the like. The first phase 22a may comprise a single phase of Li (pure Li phase). For example, the pure Li phase “Li” and the alloy phase “LiE¹” may form a solid solution “Li+LiE¹”.

The second phase 22b includes Li and a second element. The second phase 22b may include an intermetallic compound of Li and a second element, an alloy, or the like. The second phase 22b may comprise, for example, an alloying phase “LiE²”.

In the cross section of the metal anode layer 22, the area ratio “S₂/S₁” of the second phase 22b to the first phase 22a may be, for example, 1×10⁻⁶% to 95%. The area ratio “S₂/S₁” may be, for example, 1×10⁻⁵% or more, 1×10⁻³% or more, 1×10⁻¹% or more, 1% or more, 30% or more, 60% or more, or 90% or more. The area ratio “S₂/S₁” may be, for example, 90% or less, 60% or less, 30% or less, 1% or less, 1×10⁻¹% or less, 1×10⁻³% or less, or 1×10⁻⁵% or less. For example, the relation of “1×10⁻⁵%≤S₂/S₁≤90%” may be satisfied.

When the second phase 22b forms a dispersed phase, the individual second phase 22b may have any cross-sectional geometry. The aspect-ratio of the second phase 22b may be, for example, 1 to 10. The aspect-ratio of the second phase 22b may be, for example, 5 or less, 4 or less, 3 or less, 2 or less, 1.5 or less, or 1.2 or less. The second phase 22b may be, for example, 1 or more, 1.2 or more, 1.5 or more, 2 or more, 3 or more, 4 or more, or 5 or more. The aspect-ratio of the second phase 22b may be, for example, 1 to 4.

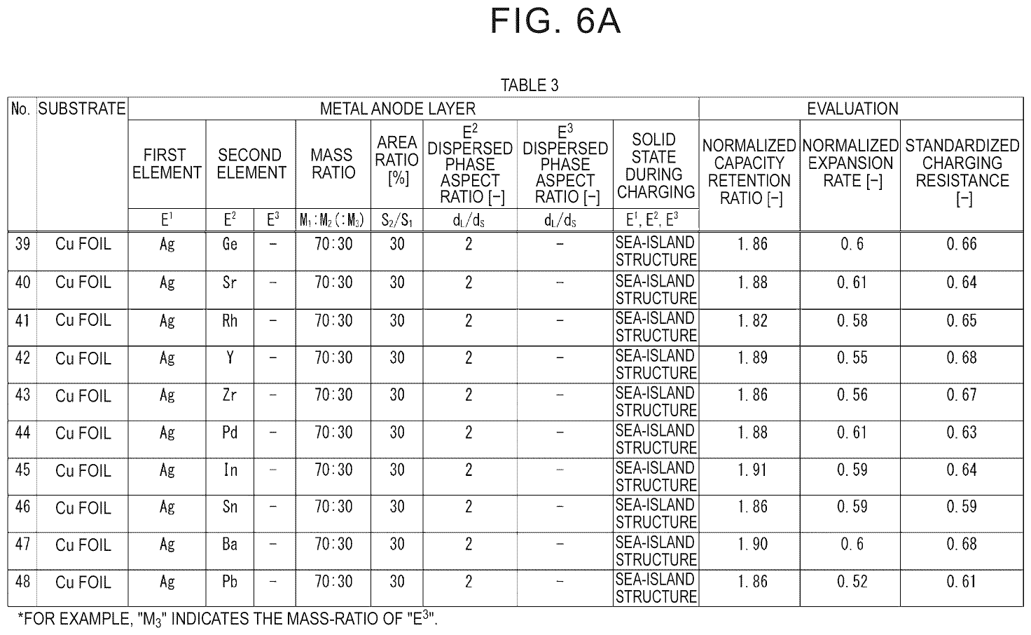

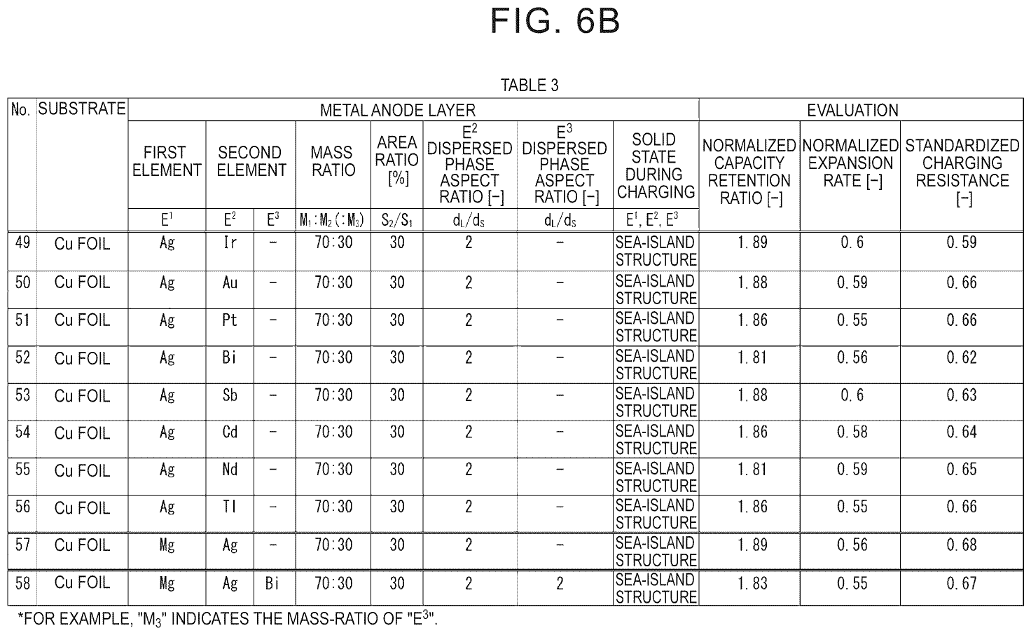

The second phase 22b may comprise two or more dispersed phases. Each dispersed phase includes a second element that is different from each other. The aspect ratio of each dispersed phase may be the same or different. If the second phase 22b comprises a first dispersed phase (E² dispersed phase) and a second dispersed phase (E³ dispersed phase) (see No. 58 in FIG. 6B), the relation of the mass-ratio, for example “first dispersed phase:second dispersed phase=2:1 to 1:2”, may be satisfied.

### Cathode

The cathode 10 may include, for example, a substrate and a cathode active material layer. The substrate may include, for example, a Al foil. The cathode active material layer may be formed on the surface of the substrate. The cathode active material layer includes a cathode active material. The cathode active material layer may further include a conductive material, a binder, and the like. The cathode active material may include, for example, at least one selected from the group consisting of Li[NiCoMn]O₂, Li[NiCoAl]O₂, Li[NiMn]₂O₄, LiMnO₂, and Li[MnFe]PO₄. In addition, [NiCoMn] and the like indicate that the sum of the compositional ratios in parentheses is 1. As long as the sum is 1, the composition ratio of each component is arbitrary. For example, it is also acceptable for the composition ratio of one or more components to be zero.

### Electrolyte

The electrolyte may include, for example, an electrolyte solution. The electrolyte solution is a liquid electrolyte. The electrolyte solution includes a Li salt (supporting electrolyte) and solvents. Li content may be, for example, from 0.5 to 2M (mol/L). Li salt may include, for example, at least one type selected from the group consisting of the following: LiPF₆, LiBF₄, LiN(SO₂F)₂ “LiFSI”, and LiN(SO₂CF₃)₂ “LiTFSI”. The solvents may include, for example, at least one selected from the group consisting of ethylene carbonate (EC), propylene carbonate (PC), dimethyl carbonate (DMC), diethyl carbonate (DEC), ethyl methyl carbonate (EMC), monofluoroethylene carbonate (FEC), tetrahydrofuran (THF), 1,4-dioxane (DOX), 1,3-dioxolane (DOL), 1,2-dimethoxyethane (DME), 1,2-diethoxyethane (DEE), and hydrofluoroether (HFE). The electrolyte solution may further contain an optional additive.

### Manufacture of Batteries

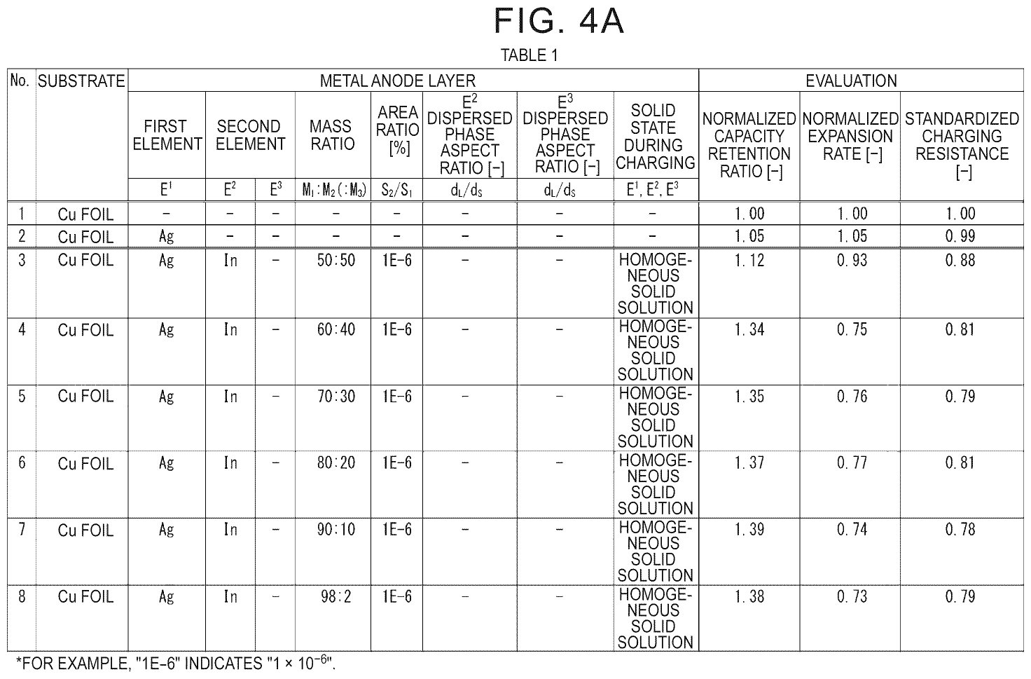

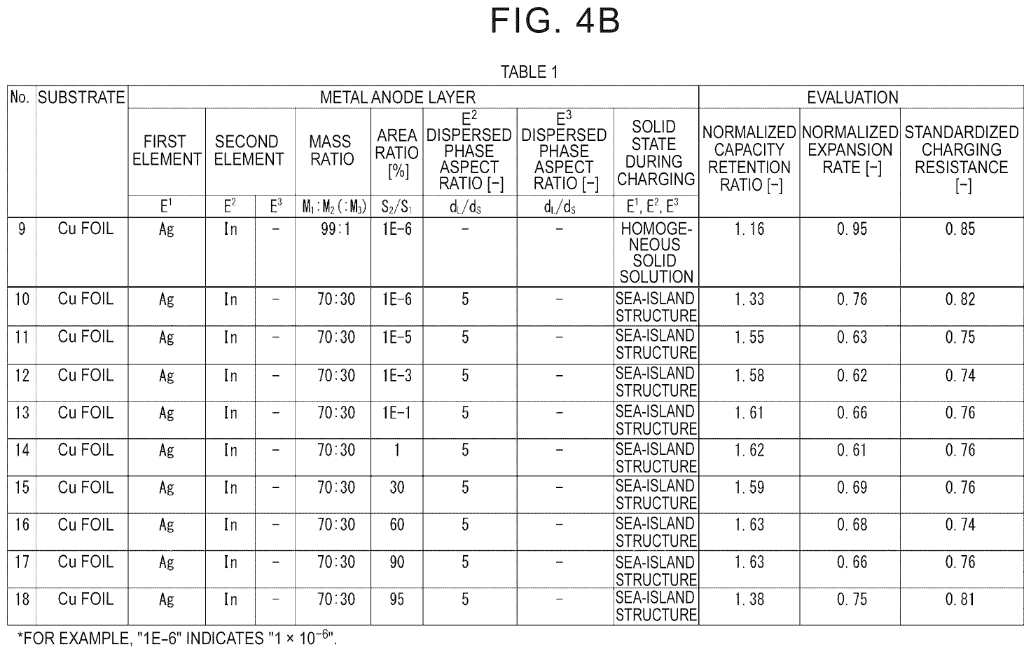

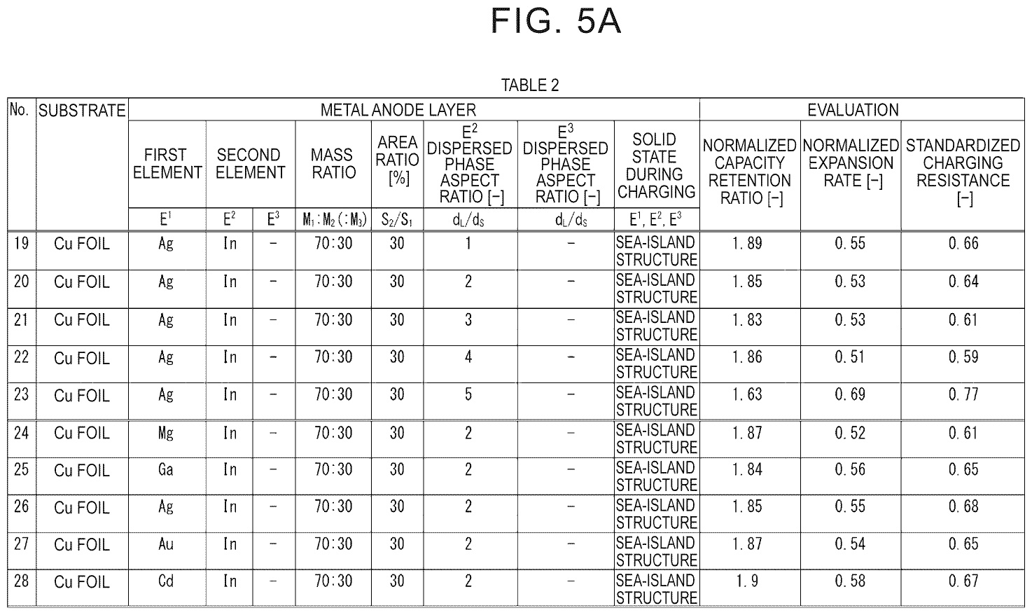

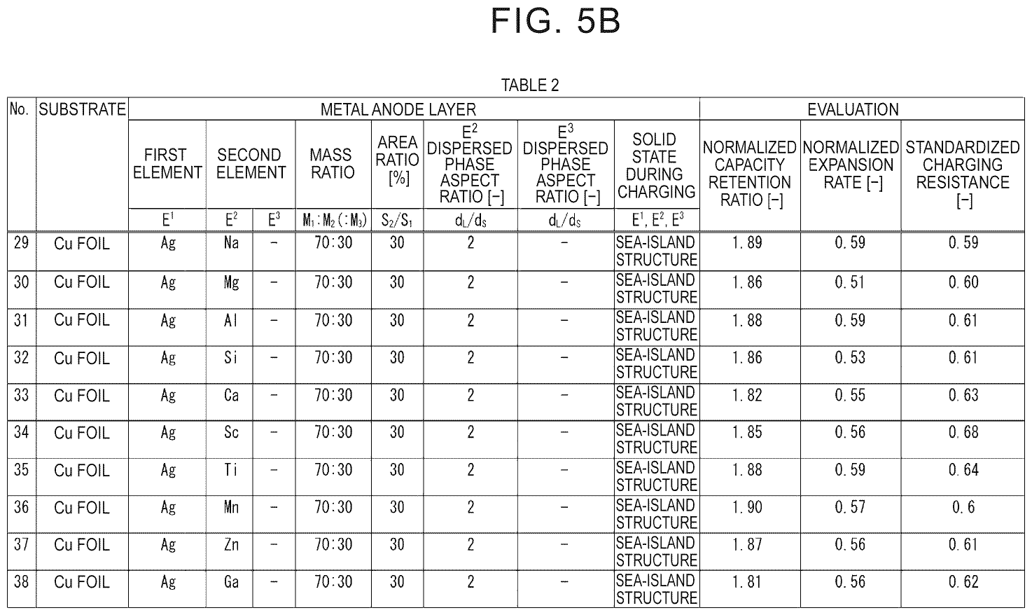

FIGS. 4A and 4B are Table 1 showing experimental results. FIGS. 5A and 5B are Table 2 showing experimental results. FIGS. 6A and 6B are Table 3 showing experimental results. Test batteries related to No. 58 (hereinafter referred to as “cells”) were manufactured from No. 1.

### No. 1

As a substrate, a Cu foil (commercially available product, hereinafter the same) was prepared. A power generation element was formed by laminating a substrate (anode), a separator, and a cathode. The power generation element was housed in an outer casing. The electrolyte solution was injected into the exterior body. By sealing the outer casing, a cell was manufactured. The main elements of the cell are as follows.
Cathode active material: Li[Ni_{1/3}Co_{1/3}Mn_{1/3}]O₂
Separator: porous film made of polyolefin (thickness: 20 μm)
Electrolyte solution: LiPF₆ (1 mol/L), EC/DMC (1:1) volume

### Conditioning Process

The cell was subjected to conditioning. That is, in an environment of 40° C., a constant-current constant-voltage (CCCV) charge was performed once between 3.0 and 4.3 V according to the current rates of 0.01 C. “C” is a symbol representing the current rate. At 1 C rates, the theoretical capacitance of the cell is flowed over an hour. The charge causes the metal anode layers to contain Li.

### No. 2

A Ag was deposited on the surface of Cu foil to form a metal anode layer. Except for this, the cells were manufactured in the same way as No. 1.

### No. 3

Ag and In were co-deposited on Cu foil to form metal anode layers. The metal anode layer was annealed to prepare an anode. Except for these, cells were manufactured in the same manner as No. 1.

### No. 4 to No. 57

A cell was fabricated similar to No. 1 except that the anode was prepared in the following manner. A first element is deposited on Cu foil to form a first layer. The surface of the first layer is covered by a mask. A plurality of holes having a predetermined diameter are formed in the mask. The second element is deposited on the surface of the first layer via the mask to form the second layer. The mask is removed. Thereafter, the formation of the first layer and the formation of the second layer are alternately repeated to form the metal anode layer. The specific content of the first element “E¹” and the second element “E²” is shown in the tables of FIGS. 4A to 6B.

### No. 58

A cell was fabricated similar to No. 1 except that the anode was prepared in the following manner. A first element is deposited on Cu foil to form a first layer. The surface of the first layer is covered by a first mask. A plurality of holes having a predetermined diameter are formed in the first mask. A second layer is formed by depositing the second element “E²” on the first layer via the first mask. The first mask is removed. The surface of the second layer is covered by a second mask. A plurality of holes having a predetermined diameter are formed in the second mask. The holes of the second mask and the holes of the first mask do not overlap each other. A third layer is formed by depositing the second element “E³” on the second layer via the second mask. The formation of the first layer, the second layer, and the third layer is repeated in this order to form the metal anode layer. The details of the first element “E¹” and the second element “E², E³” are shown in the tables in FIGS. 6A and 6B.

### Evaluation

### Capacity Maintaining Rate

Cycle durability tests were performed on the cells after the conditioning process. In other words, the charge/discharge was repeated 200 times in a range of 3.3 to 4.2 V in a constant current (CC) mode according to the current rate of 1 C at a temperature of 25° C. The discharge capacity of the 200-th cycle, by being divided by the discharge capacity of the first cycle, the capacity retention rate was calculated. The “normalized capacity retention rate” in FIGS. 4A to 6B is normalized by setting the capacity retention rate of No. 1 to “1”. The higher the capacity retention, the better the cycle durability.

### Expansion Rate

SOC of the cell after conditioning was adjusted to 0%. The thickness of the anode “W₁” was measured by in-situ film thickness measuring cell. After the cycling endurance test, SOC of the cell was adjusted to 0%. As in the beginning, the thickness of the anode “W₂” was measured. The expansion rate was calculated by the equation of “expansion rate=W₂/W₁”. Expansion is expressed as a percentage (%). The “normalized expansion rate” in FIGS. 4A to 6B is normalized by setting the expansion rate of No. 1 to “1”. It is believed that the lower the expansion rate, the lower the growth of Li dendrites.

### Charging Resistance

The open circuit voltage of the cell was adjusted to 3.7 V. In a 30° C. setting, the cell was charged for 8 seconds by the current rate of 5 C, so that the voltage-rise “ΔV” was measured. The charging resistance was calculated by the formula of “charging resistance=ΔV/I”. “I” is the current corresponding to 5 C. The “normalized charging resistance” in FIGS. 4A to 6B is a value standardized by setting the charging resistance of No. 1 to “1”. It is considered that Li dendrites are less likely to be generated as the charging resistance is lower.

### Results

In Table 1 (FIGS. 4A and 4B), No. 1 to No. 3 shows that the metal anode layer contains both the first element and the second element, which tends to improve cycle-durability.

In Table 1, from No. 3 to No. 9, when the relation of “M₁:M₂=60:40 to 98:2” is satisfied with respect to the mass ratio of the first element and the second element, the cycle durability tends to be remarkably improved. In the metal anode layers of No. 3 to No. 9, a solid solution was formed by uniformly dissolving the first element and the second element in solid solution. In the metal anode layers after No. 10, the first element and the second element formed a sea-island structure.

In Table 1, in No. 10 to No. 18, when the relation of “1×10⁻⁵%≤S₂/S₁≤90%” is satisfied with respect to the area ratio of the second element to the first element, the cycle durability tends to be improved.

In Table 2 (FIGS. 5A and 5B), when the aspect ratio of the second phase (dispersed phase) containing the second element is 1 to 4 in No. 19 to No. 23, the cycle-durability tends to be improved.

In Table 2, No. 24 to No. 28 shows that when Mg, Ga, Ag, Au, Cd is the first element, the cycle-durability tends to be improved.

In Tables 2 and 3 (FIGS. 6A and 6B), Na, Mg, Al, Si, Ca, Sc, Ti, Mn, Zn, Ga, Ge, Sr, Rh, Y, and Zr, Pd, In, Sn, Ba, Ag, Pb, Ir, Au, Pt, Bi, Sb, Cd, Nd, Tl tend to improve cycle-durability when the second element is No. 29 to No. 57.

In Table 3, even if the second element (dispersed phase) is a two-component system “E², E³”, cycle durability tends to be improved.

What is claimed is:

1. A lithium-ion battery comprising a cathode, an anode, and an electrolyte, wherein
the anode includes a metal anode layer,
the metal anode layer includes Li, a first element, and a second element,
the second element is different from the first element,
the first element is at least one kind selected from the group consisting of Mg, Ga, Ag, Au, and Cd,
the second element is at least one kind selected from the group consisting of Na, Mg, Al, Si, Ca, Sc, Ti, Mn, Zn, Ga, Ge, Sr, Rh, Y, Zr, Pd, In, Sn, Ba, Ag, Pb, Ir, Au, Pt, Bi, Sb, Cd, Nd, and Tl,
the following relationship is satisfied: M₁:M₂=60:40 to 98:2,
the M₁ represents a mass of the first element contained in the metal anode layer, and
the M₂ represents a mass of the second element contained in the metal anode layer.

2. The lithium-ion battery according to claim 1, wherein:
the metal anode layer includes a first phase and a second phase;
the first phase includes Li and the first element;
the second phase includes Li and the second element;
in a cross section of the metal anode layer, the following relationship is satisfied: 1×10⁻⁵%≤S₂/S₁≤90%,
the S₁ represents a total area of the first phase in the cross section; and
the S₂ represents a total area of the second phase in the cross section.

3. The lithium-ion battery according to claim 2, wherein:
the first phase includes a continuous phase;
the second phase includes a dispersed phase dispersed in particles in the continuous phase; and
in the cross section of the metal anode layer, an aspect ratio of the second phase is 1 to 4.

4. The lithium-ion battery according to claim 1, wherein:
the anode further includes a substrate;
the metal anode layer is provided on a surface of the substrate; and
the electrolyte includes an electrolyte solution.

5. A lithium-ion battery comprising a cathode, an anode, and an electrolyte solution, wherein
the anode includes a substrate and a metal anode layer,
the metal anode layer is provided on a surface of the substrate,
the metal anode layer includes Li, a first element, and a second element,
the second element is different from the first element,
the first element is at least one kind selected from the group consisting of Mg, Ga, Ag, Au, and Cd,
the second element is at least one kind selected from the group consisting of Na, Mg, Al, Si, Ca, Sc, Ti, Mn, Zn, Ga, Ge, Sr, Rh, Y, Zr, Pd, In, Sn, Ba, Ag, Pb, Ir, Au, Pt, Bi, Sb, Cd, Nd, and Tl,
the following relationship is satisfied: M₁:M₂=60:40 to 98:2,
the M₁ represents a mass of the first element contained in the metal anode layer,
the M₂ represents a mass of the second element contained in the metal anode layer,
the metal anode layer includes a first phase and a second phase,
the first phase includes Li and the first element,
the second phase includes Li and the second element,
in a cross section of the metal anode layer, the following relationship is satisfied: 1×10⁻⁵%≤S₂/S₁≤90%,
the S₁ represents a total area of the first phase in the cross section,
the S₂ represents a total area of the second phase in the cross section,
the first phase includes a continuous phase,
the second phase includes a dispersed phase dispersed in particles in the continuous phase, and
in the cross section of the metal anode layer, an aspect ratio of the second phase is 1 to 4.
